(19) United States
(12) Patent Application Publication
(10) Pub. No.: US 2008/0223980 A1
(43) Pub. Date: Sep. 18, 2008

(54) BUBBLE GLIDER

(76) Inventors: Dale Po-Kun Fung, North York (CA); Evelyn Yan-Leung Fung, North York (CA)

Correspondence Address: Dale Fung, 27 Renata Royalway, North York, ON, M2H 1L1, CA

(21) Appl. No.: 11/685,233

(22) Filed: Mar. 13, 2007

(51) Int. Cl. B64C 31/02

(52) U.S. Cl. 244/16

(57) ABSTRACT

This invention is a “bubble glider” which is a modified hybrid of the hot-air balloon and the glider. It has a distinct undulating forward motion. A simple bubble glider has a soft air-bubble, a hard air-bubble and a thin body and is made of 0.25 mm PVC sheets. It is used inside a completely sealed water tank with an external control unit. An operator uses the control unit to vary the buoyancy of the soft air-bubble and completely control the motion of the bubble glider. Specifically, the glider can glide forward and backward, change direction, take off and land vertically, float motionless and so on. In generalization, bubble gliders can be of many shapes and sizes, and made of, practically, any material. They can be designed to operate in totally closed containers or in open environments such as open water tanks, reservoirs, lakes, oceans and skies.

### BACKGROUND OF THE INVENTION

This invention relates to the hot-air balloon. The hot-air balloon maintains airborne by buoyancy and changes altitude by warming or cooling the air inside the balloon. It can only float and drift with the winds at different altitudes. There is no active directional control. This invention also relates to the glider and the hang glider, which have wings and fly under their own gravity. They can only rise higher with the help of rising thermals or air currents. The glider needs a runway for assisted take-off and landing. The hang glider is usually launched by running into the wind over a steep hill. It flies with a pilot underneath its wings and the flight is controlled by the pilot shifting his/her own weight. Moreover, this invention also relates to the underwater toy glider which, if held and released underwater, glides upward to the surface under its own built-in buoyancy.

### BRIEF SUMMARY OF THE INVENTION

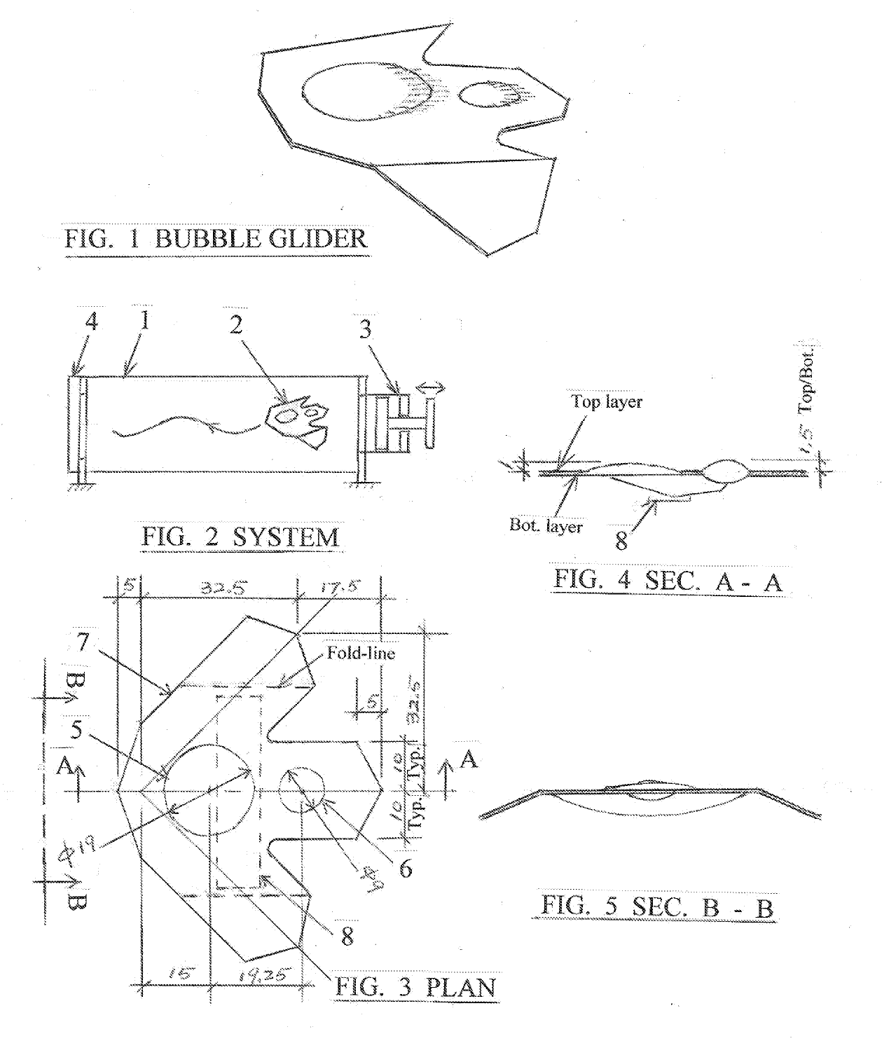

An object of this invention is to introduce a “bubble glider” as shown in FIG. 1. In principle, if we neglect the details the bubble glider is very nearly a hybrid of the hot-air balloon and glider with modifications. The modified hybrid is superior in a sense that it can glide, in the forward direction, not only downward under gravity but also upward when there is positive buoyancy. A simple system consists of a bubble glider, a water tank and a control unit as shown in FIG. 2. The bubble glider is initially balanced to neutrally buoyant and put inside the water tank. The tank is then closed and sealed completely. An operator uses the control unit to vary remotely the volume of a soft air-bubble on the bubble glider and by so doing controls the buoyancy of the bubble glider. By changing the buoyancy in different ways the operator can remotely manipulate the motion of the glider. For example, varying the buoyancy back and forth about the neutrally buoyant condition with an appropriate frequency, the operator can move the bubble glider forward in an undulating manner as illustrated in FIG. 2.

The undulating forward motion is unique to the bubble glider and is superior because it has improved the conventional glider by adding an upward gliding capability. But it also implies that the bubble glider can not have a sustained level flight. Besides, the bubble glider is capable of moving backward, changing direction, floating motionless, pitching and so on. It can take-off and land vertically, like the hot-air balloon. It is observed that the bubble glider needs power only in the brief moment when it is switching between upward (downward) and downward (upward) motion. For example, in the forward undulating motion, power is required only intermittently at the crests and troughs of the wavy path of motion.

In principle, the bubble glider may be of many shapes and sizes, and made of practically any material. It can be designed to operate in either closed containers or open environments such as water tanks, reservoirs, oceans and skies. It can also be designed for systems with one fluid or several layers of fluids of different densities.

### BRIEF DESCRIPTION OF THE SEVERAL VIEWS OF THE DRAWING

1. FIG. 1—A perspective view of a simple bubble glider.

2. FIG. 2—A sample of bubble glider systems. Part 1, a sealed water-tank of diameter 100 mm and length 300 mm; part 2, a bubble glider; part 3, a volume or pressure control unit; part 4, an opening for entry.

3. FIG. 3—A plan view of a simple bubble glider with parts 5, 6, 7 and 8 being the soft air-bubble, the hard air-bubble, the thin body and a movable weight respectively. It is made of 0.25 mm PVC sheet and dimensions are given in mm with a scale of 1:1.

4. FIG. 4—Section view A-A along the longitudinal axis and dimensions are given without thickness of PVC sheet with a scale of 1:1.

5. FIG. 5—Section view B-B. Exact size and position of the movable weight part 8 must be determined at the final stage of finding the neutral buoyant condition. Scale of drawing is 1:1.

### DETAILED DESCRIPTION OF THE INVENTION

A simple bubble glider made of 0.25 mm PVC sheet is described in FIG. 3 to FIG. 5. The soft bubble, part 5, is easily expandable and contractible due to its structurally weak configuration. The hard bubble, part 6, is relatively rigid due to its structurally strong configuration. The thin body is Part 7. Both bubbles (part 5 and 6) are filled with air under atmospheric pressure. They are placed along the longitudinal axis of the body. The forward end or the bow of the bubble glider is the end near the soft bubble. The glider is balanced in open water to nearly neutral-buoyant before putting it inside the water-tank. The tank is then closed and sealed completely.

There is a control unit, part 3, outside of the wall as shown in FIG. 2. It is used for varying the volume or pressure inside the tank. The changes of volume or pressure are transmitted through the water to the soft bubble. When volume of the soft bubble is changed, buoyancy of the bubble glider will change and the center of buoyancy will shift along the longitudinal axis of the glider. The bubble glider is designed such that at positive buoyancy it rises with nose up, and at negative buoyancy it sinks with nose down. The nose-up and nose-down postures ensure that the glider will always move forward. If the changes of buoyancy are applied back and forth about the neutrally buoyant condition at an appropriate frequency the glider will glide forward in an undulating manner as shown in FIG. 2. If the changes are applied at a somewhat higher frequency the glider will go backward. During a sharp rise with nose-up, if buoyancy is drastically reduced, the glider will move backward and downward, and then turn sideways due to the lost of balance. As a result, the glider heads downward in a different direction. Therefore, with the above three most essential maneuvers, the operator can remotely direct the glider to go anywhere via any route inside the tank. It is observed that the bubble glider is driven initially by net buoyancy to bring about the gliding action.

Changing direction is one of the most difficult maneuvers to realize because bubble gliders are generally built with symmetry about the longitudinal axis. In order for the glider to be able to change direction this symmetry must somehow be destroyed or deviated. There are symmetries of geometry, mass distribution and buoyancy of the body. One of them must be deviated but this deviation must not affect the straight forward motion seriously.

Besides the maneuvers described above the bubble glider is capable of taking off and landing nearly vertically when buoyancy changes only slightly. Also the glider is capable of pitching up and down and floating motionless when buoyancy changes back and forth at certain frequencies. An experienced operator may be able to develop more motion styles by simply varying the buoyancy at different frequencies. For generalization, a successfully designed bubble glider should possess the following essential features: a thin neutrally buoyant and appropriately shaped body, a well-positioned soft bubble and a well-planned direction-changing scheme.

Sometimes, it is necessary to reduce the size of a bubble glider without having to change the bubbles e.g. for keeping the structurally weak configuration of the soft bubble. This can be done by putting some dry-weights inside the bubbles to replace the removed wet-weights of the external body. For controlling the softness or hardness of the bubbles an alternative is to vary the pressure of the fluid inside the bubbles. Another class of bubble glider may be called “tool carriers” which carry tools to perform specific tasks, such as a set of claws for picking.

The water in the tank serves two functions. Firstly, it transmits the changes of volume or pressure signals to the soft bubble, which obviously requires a totally enclosed environment. Secondly, it provides an environment for the bubble glider to move. It is obvious that if the control unit is attached directly to the bubble glider, the first function of transmitting signal can be eliminated. Then there is no longer any need for a closed environment and it can be an open system. This is a major step in the expansion of the application of bubble glider into any appropriate fluid environments. The simple set up in FIG. 2 is only one of a wide variety of conceivable bubble glider systems.

In conclusion, bubble gliders may be of many shapes and sizes, and constructed of practically any material. They can be designed for closed systems which, in general, have the external control units. Also they can be for open systems such as open water tanks, reservoirs, lakes, oceans, skies and so on; of which the control units are attached directly to the bubble gliders. The above systems may be of single-fluid or multi-layer of fluids of different densities.

1. A bubble glider which is neutral-buoyant in water is made up of, at least, one soft air-bubble, one hard air-bubble and a thin body; and is so constructed that it can be driven, by varying in different ways the volume or buoyancy of the soft air-bubble, to glide forward in a distinct undulating manner and backward, change direction, pitch up and down and so on, under the command of an operator.

2. A bubble glider in claim 1 of which the surrounding water represents a fluid of higher density and the air inside the bubbles represents a fluid of lower density.

3. A bubble glider in claim 1 of which the soft bubble and/or the hard bubble can be explicitly or implicitly integrated with the body.

4. A bubble glider in claim 1 of which the soft bubble and/or hard bubble can be replaced by a system of soft bubbles and/or a system of hard bubbles respectively.

5. A bubble glider in claim 1 of which the softness and hardness of the bubbles can be achieved by controlling the structural stiffness of the bubbles in terms of size, shape and material.

6. A bubble glider in claim 1 of which the softness and hardness of the bubbles can be achieved by controlling the pressure of the fluid inside the bubbles.

7. A bubble glider in claim 1 of which the body size can be reduced efficiently, without changing the sizes of the bubbles, by replacing the removed body wet-weights by the same total dry-weights inside the bubbles.

8. A bubble glider in claim 1 can be converted to vehicles that carry tools to perform specific tasks.

9. A bubble glider in claim 1 can be of many shapes and sizes, and made of practically any material or combination of materials.

10. A bubble glider in claim 1 can be made for completely closed systems filled with one fluid or several layers of fluids of different densities with, typically, an external volume or pressure control unit.

11. A bubble glider in claim 1 can be made for open systems including the man-made and the natural environments with, typically, the volume or pressure control unit attached to the bubble glider.
